(19) United States
(12) Patent Application Publication
(10) Pub. No.: US 2009/0167795 A1
(43) Pub. Date: Jul. 2, 2009

(54) LIQUID SUPPLY UNIT, LIQUID EJECTING APPARATUS, AND LIQUID SUPPLYING METHOD

(75) Inventor: Hideya YOKOUCHI, Okaya-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/340,949

(22) Filed: Dec. 22, 2008

(30) Foreign Application Priority Data
Dec. 27, 2007 (JP) 2007-336516
Aug. 29, 2008 (JP) 2008-222051

(51) Int. Cl. B41J 29/38

(52) U.S. Cl. 347/6

(57) ABSTRACT

A liquid supply unit includes a liquid supply passage that supplies liquid from a liquid supply source on the upstream side to a liquid consuming section on the downstream side, a pump that operates using a part of the liquid supply passage as a pump chamber, and a control unit that determines the need for driving the pump after the consuming of liquid in the liquid consuming section and drives the pump on the basis of the determination.

### BACKGROUND

The entire disclosure of Japanese Patent Application No. 2007-336516, filed Dec. 27, 2007 and Japanese Patent Application No. 2008-222051, filed Aug. 29, 2008, are expressly incorporated herein by reference.

1. Technical Field

The present invention relates to a liquid supply unit that supplies liquid from a liquid supply source on the upstream side to an ink consuming section on the downstream side, a liquid ejecting apparatus, and a liquid supplying method.

2. Related Art

Hitherto, an ink jet printer (hereinafter referred to as “printer”) has been widely known as a liquid ejecting apparatus that ejects liquid onto a target. This printer ejects ink (liquid) supplied to a recording head (liquid consuming section), from nozzles formed in the recording head, thereby performing printing onto a recording medium as a target. Recently, there has been proposed a printer that has a pump in the middle of an ink passage (liquid supply passage) connecting an ink cartridge (a liquid supply source) with a recording head, the pump operating to supply ink under pressure from the ink cartridge to the recording head.

In such a printer, the pump repeatedly performs a suction stroke to suck ink from the ink cartridge into a pump chamber, and a discharge stroke to discharge ink out of the pump chamber to the recording head. Before the amount of ink in the pump chamber and the ink passage from the ink chamber to the recording head on the downstream side becomes smaller than the amount of ink required for the printing (consuming of liquid) performed by ejecting ink from the recording head, the pump is driven to newly suck ink into the pump chamber from the ink cartridge. So, during a suction stroke of the pump, ink cannot be supplied under pressure to the recording head, that is, a print waiting time occurs. If the pump is driven and a print waiting time occurs during the printing on a recording medium, the print quality is deteriorated.

To solve such problems, there is proposed a printer that adjusts the time to make a pump perform a suction stroke, thereby preventing the print quality from being deteriorated, and shortening the print time (for example, JP-A-2004-175005 and JP-A-2006-7585). In the printer of JP-A-2004-175005, the consumption of ink is estimated on the basis of conditions of printing on a recording medium. In the printer of JP-A-2006-7585, the amount of ink required for printing per recording medium is estimated on the basis of the consumption of ink used in the previous printing on a plurality of recording media. When the estimated consumption becomes larger than the amount of ink in the pump chamber and the downstream ink passage leading to the recording head, the pump is driven to suck ink into the pump chamber.

In the cases of the printers of JP-A-2004-175005 and JP-A-2006-7585, when an instruction to perform printing on a recording medium is input, the consumption of ink required for the printing is estimated and the need for pump driving is determined on the basis of the estimated consumption just before the start of the printing. If it is determined that the pump needs to be driven, the pump is driven to suck ink into the pump chamber before the start of printing. So, if it is determined that the pump needs to be driven just before the start of printing, a waiting time occurs from the print instruction to the start of printing, and the printing efficiency is reduced.

### SUMMARY

An advantage of some aspects of the invention is to provide a liquid supply unit that can improve the liquid consuming efficiency in a liquid consuming section by adjusting the time to drive a pump located in the middle of a liquid supply passage that supplies liquid from a liquid supply source to the liquid consuming section, a liquid ejecting apparatus, and a liquid supplying method.

According to a first aspect of the invention, a liquid supply unit includes at least one liquid supply passage that supplies liquid from a liquid supply source on the upstream side to a liquid consuming section on the downstream side, a pump that operates using a part of the liquid supply passage as a pump chamber, and a control unit that determines the need for driving the pump after the consuming of liquid in the liquid consuming section and drives the pump on the basis of the determination.

The need for driving the pump is determined after the consuming of liquid in the liquid consuming section. If it is determined that the pump needs to be driven, the pump is driven. The pump is not driven just before the consuming of liquid, such as printing, in the liquid consuming section. Since the consuming of liquid, such as printing, is not delayed by being interrupted by the pump driving, the efficiency of the consuming of liquid in the liquid consuming section can be improved.

It is preferable that the control unit drive the pump when the control unit determines that the liquid consumption consumed in the consuming of liquid in the liquid consuming section is larger than or equal to a threshold consumption preliminarily set as a datum for determining that the pump needs to be driven.

The need for driving the pump is determined on the basis of the consumption of liquid consumed in the consuming of liquid. When the consumption is small, the pump is not driven. So, the number of times of suction strokes is small compared to the case where a suction stroke is performed every time liquid is consumed. Thus, it is possible to extend the time the liquid supply unit can supply liquid and to improve its supply rate.

It is preferable that when the control unit determines that a unit liquid consumption consumed in a unit of consuming of liquid in the liquid consuming section is smaller than the threshold consumption, the control unit store the unit liquid consumption in a predetermined storage unit as a total liquid consumption, and when the control unit determines that the total liquid consumption is larger than or equal to the threshold consumption, the control unit drive the pump.

If the unit liquid consumption consumed in a unit of consuming of liquid is smaller than the threshold consumption, the unit liquid consumption is added to the total liquid consumption. When the total liquid consumption becomes larger than the threshold consumption, the pump is driven. So, even when the unit liquid consumption varies, the liquid consumption can be prevented from exceeding the amount of liquid that can be supplied.

It is preferable that the threshold consumption be set so as to be smaller than or equal to an amount obtained by subtracting the maximum liquid consumption that can be consumed in a unit of consuming of liquid in the liquid consuming section from the amount of liquid that can be supplied from the liquid supply source to the liquid consuming section by a single driving of the pump.

In a condition in which the pump performs a suction stroke and the amount of liquid that can be supplied is the maximum, when the same amount of liquid as the threshold consumption is consumed, the amount of liquid that can be supplied is larger than the maximum liquid consumption required for a unit of consuming. If the liquid consumption is smaller than or equal to the threshold consumption, liquid can be supplied without driving the pump during a unit of consuming of liquid.

It is preferable that the at least one liquid supply passage include a plurality of liquid supply passages that can supply different liquids from their respective liquid supply sources on the upstream side to the liquid consuming section on the downstream side by the operation of their respective pumps, and when the control unit determines that the consumption of at least one of the liquids supplied via the plurality of liquid supply passages is larger than or equal to the threshold consumption, the control unit drive all the pumps.

Even in the case where the consumptions of liquids consumed in the consuming of liquid vary, when the consumption of any one of the liquids exceeds the threshold consumption, all the pumps are driven. So, the amount of liquid that can be supplied can be increased in every liquid supply unit in a short time compared to the case where the pumps are individually driven.

According to a second aspect of the invention, a liquid ejecting apparatus includes a liquid consuming section that consumes liquid at least by ejecting liquid onto a target, and the above liquid supply unit that supplies liquid to the liquid consuming section from a liquid supply source.

The liquid supplied to the liquid consuming section is ejected onto a target. After liquid is ejected onto a target, if it is determined that the pump needs to be driven, the pump is driven. Since the need for driving the pump is determined after the ejection of liquid, the waiting time from an instruction to eject liquid to the start of liquid ejection can be shortened, and the efficiency of liquid ejection can be improved. In addition, since the need for driving the pump is determined every time liquid is ejected onto a unit of target, the need for driving the pump during the ejection can be reduced and the efficiency of liquid ejection onto a target can be improved.

According to a third aspect of the invention, a method for supplying liquid to a liquid consuming section via a liquid supply passage that supplies liquid from a liquid supply source on the upstream side to the liquid consuming section on the downstream side by driving a pump that has a pump chamber constituting the liquid supply passage, comprising determining the need for driving the pump after the consuming of liquid in the liquid consuming section, and driving the pump on the basis of the determination.

In this case, the same advantageous effect as that of the above liquid supply unit can be obtained.

It is preferable that it be determined whether or not the liquid consumption consumed in the consuming of liquid in the liquid consuming section is larger than or equal to a threshold consumption preliminarily set as a datum for determining that the pump needs to be driven.

In this case, the same advantageous effect as that of the above liquid supply unit can be obtained.

It is preferable that when it is determined that a unit liquid consumption consumed in a unit of consuming of liquid in the liquid consuming section is smaller than the threshold consumption, the unit liquid consumption be stored in a predetermined storage unit as a total liquid consumption, and it be determined whether or not the total liquid consumption is larger than or equal to the threshold consumption.

In this case, the same advantageous effect as that of the above liquid supply unit can be obtained.

### BRIEF DESCRIPTION OF THE DRAWINGS

The invention will be described with reference to the accompanying drawings, wherein like numbers reference like elements.

FIG. 1 is a schematic view of an ink jet printer according to an embodiment.

FIG. 2 is a block diagram of a control section.

FIG. 3 is a flowchart of a pomp driving process.

FIG. 4A is a schematic view of a liquid supply unit at the time of a suction stroke of a pump.

FIG. 4B is a schematic view of a liquid supply unit at the time of a discharge stroke of a pump.

FIG. 5A is a schematic view of a liquid supply unit when the amount of ink that can be supplied is small.

FIG. 5B is a schematic view of a liquid supply unit at the time of ink ejection and a discharge stroke of a pump.

### DESCRIPTION OF EXEMPLARY EMBODIMENTS

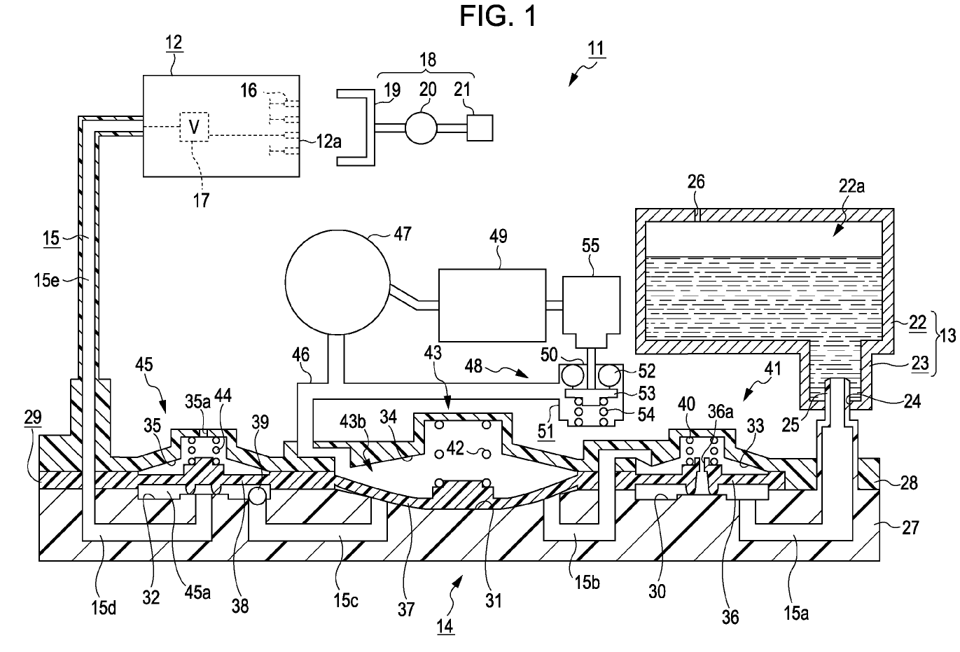

An ink jet recording apparatus (hereinafter referred to as “printer”), which is a kind of liquid ejecting apparatus, according to an embodiment of the present invention will now be described with reference to FIGS. 1 to 5. As shown in FIG. 1, the printer 11 of this embodiment has a recording head 12 and at least one ink supply unit 14. The recording head 12 serves as a liquid consuming section that consumes ink (liquid) by ejecting ink (liquid) onto recording paper (not shown) serving as a target. The at least one ink supply unit 14 serves as a liquid supply unit that supplies the recording head 12 with ink contained in an ink cartridge 13 serving as a liquid supply source. The at least one ink supply unit 14 is provided with an ink passage (a liquid supply passage) 15. The upstream end of the ink passage 15 is connected to the ink cartridge 13. The downstream end of the ink passage 15 is connected to the recording head 12. The ink passage 15 supplies ink from the ink cartridge 13 on the upstream side to the recording head 12 on the downstream side.

The at least one ink supply unit 14 includes a plurality of ink supply units 14 corresponding to the colors (kinds) of inks used in the printer 11 (corresponding to cyan, magenta, yellow, and black inks in this embodiment). Each ink passage 15 is connected to the recording head 12, in which a plurality of liquid consuming sections corresponding to the plurality of ink supply units 14 are integrally formed.

Since the ink supply units 14 have the same structure, FIG. 1 shows one of the ink supply units 14, the ink cartridge 13 corresponding thereto, and the recording head 12. An example in which ink is supplied via the ink passage 15 of the ink supply unit 14 shown in FIG. 1 from the ink cartridge 13 on the upstream side to the recording head 12 on the downstream side will hereinafter be described.

As shown in FIG. 1, the recording head 12 has the same number of nozzles 16 as the number of ink supply units 14 (four nozzles 16 in this embodiment). The nozzles 16 open on a nozzle forming surface 12a that faces a platen (not shown). Each nozzle 16 is supplied with ink from the ink passage 15 of the corresponding ink supply unit 14 via a valve unit 17. The valve unit 17 is provided with a pressure chamber (not shown) that temporarily stores ink flowing therein from the ink passage 15 and communicates with the nozzle 16. When ink is ejected from the nozzle 16, an amount of ink corresponding to the ink consumption (liquid consumption) q consumed in the ejection of ink is made to flow into the pressure chamber from the ink passage 15 by the opening and closing of a passage valve (not shown).

A maintenance unit 18 is provided at a home position where the recording head 12 is located when printing is not performed. The maintenance unit 18 cleans the recording head 12 to clear the clog in the nozzles 16 of the recording head 12. The maintenance unit 18 has a cap 19, a suction pump 20, and a waste liquid tank 21. The cap 19 can come in contact with the nozzle forming surface 12a of the recording head 12 so as to surround the nozzles 16. The suction pump 20 is driven when ink is sucked out of the cap 19. The ink sucked out of the cap 19 by the suction pump 20 is discharged as waste ink into the waste liquid tank 21. At the time of cleaning, the cap 19 is moved from the position shown in FIG. 1 so as to be brought into contact with the nozzle forming surface 12a of the recording head 12, and the suction pump 20 is driven to generate negative pressure in the space inside the cap 19, thereby sucking thickened ink or ink including air bubbles out of the recording head 12 and discharging it into the waste liquid tank 21. The amount of ink sucked and discharged at this time corresponds to the ink consumption q consumed in the cleaning.

The ink cartridge 13 has a substantially box-shaped case 22. Inside the case 22 is an ink chamber 22a for storing ink. A tube 23 communicating with the ink chamber 22a protrudes downward from the lower wall of the case 22. At the end of the tube 23 is formed an ink supply port 24 through which ink can flow out. An ink supply needle 25 protrudes from the ink supply unit 14 to constitute the upstream end of the ink passage 15. When the ink cartridge 13 is connected to the ink supply unit 14, the ink supply needle 25 is inserted into the ink supply port 24. Trough the upper wall of the case 22 is formed an air communication port 26, through which the ink chamber 22a storing ink communicates with the atmosphere and the atmospheric pressure acts on the surface of the ink stored in the ink chamber 22a.

Next, the structure of the ink supply unit 14 will be described in detail. As shown in FIG. 1, the ink supply unit 14 has a first passage forming member 27, a second passage forming member 28, and a flexible member 29. The first passage forming member 27 is formed of resin and serves as a base. The second passage forming member 28 is also formed of resin and is layered on top of the first passage forming member 27. The flexible member 29 is formed, for example, of a rubber plate and is sandwiched between the first and second passage forming members 27 and 28. At a plurality of places (at three places in this embodiment) in the upper surface of the first passage forming member 27 are formed depressions 30, 31, and 32 that are circular in planar view. Two 30 and 32 of the depressions have substantially the same volume smaller than the volume of the other 31. The depressions 30, 31, and 32 are arranged in this order from the right to left in FIG. 1.

At a plurality of places (at three places in this embodiment) in the lower surface of the second passage forming member 28 are formed depressions 33, 34, and 35 that are circular in planar view. The depressions 33, 34, and 35 are opposite the depressions 30, 31, and 32, respectively, in the vertical direction. Two 33 and 35 of the depressions have substantially the same volume smaller than the volume of the other 34. The depressions 33, 34, and 35 are arranged in this order from the right to left in FIG. 1.

That is, the ink supply unit 14 enables the adoption of such a layered structure that a plurality of plate-like components are layered, by forming the depressions 30 to 32 in the same plane and forming the depressions 33 to 35 in the same plane.

At the bottom of the leftmost (in FIG. 1) depression 35 in the second passage forming member 28 is formed an air communication port 35a that communicates with the atmosphere. The flexible member 29 is sandwiched between the first passage forming member 27 and the second passage forming member 28 so that a plurality of places (three places in this embodiment) in the flexible member 29 separate the depressions 30 to 32 of the first passage forming member 27 from the depressions 33 to 35 of the second passage forming member 28. As a result, a part of the flexible member 29 located between the depression 30 of the first passage forming member 27 and the depression 33 of the second passage forming member 28 functions as a suction side valve element 36 that can be displaced by being elastically deformed between the depressions 30 and 33.

Similarly, a part of the flexible member 29 located between the depression 31 of the first passage forming member 27 and the depression 34 of the second passage forming member 28 functions as a diaphragm 37 that can be displaced by being elastically deformed between the depressions 31 and 34. Similarly, a part of the flexible member 29 located between the depression 32 of the first passage forming member 27 and the depression 35 of the second passage forming member 28 functions as a discharge side valve element 38 that can be displaced by being elastically deformed between the depressions 32 and 35.

The area in planar view of the bendable part of the suction side valve element 36 is substantially the same as that of the discharge side valve element 38. The area in planar view of the bendable part of the diaphragm 37 is larger than those of the suction side valve element 36 and the discharge side valve element 38.

As shown in FIG. 1, in the first passage forming member 27 and the second passage forming member 28 is formed a first passage 15a that connects the ink supply needle 25 protruding from the upper surface of the second passage forming member 28 and the depression 30 of the first passage forming member 27 to constitute the ink passage 15 in the ink supply unit 14. Similarly, in the first passage forming member 27, the second passage forming member 28, and the flexible member 29 is formed a second passage 15b that connects the depression 33 of the second passage forming member 28 and the depression 31 of the first passage forming member 27 to constitute the ink passage 15 in the ink supply unit 14.

Similarly, in the first passage forming member 27 is formed a third passage 15c that connects the depression 31 and the depression 32 of the first passage forming member 27 to constitute the ink passage 15 in the ink supply unit 14. At the downstream end of the third passage 15c that opens on the bottom surface of the depression 32 is provided a ball valve 39 that allows ink to flow therethrough only from the depression 31 on the upstream side to the depression 32 on the downstream side. Normally, the ball valve 39 is urged by an urging member (not shown) in a valve closing direction such that the third passage 15c is blocked.

In addition, in the first passage forming member 27, the second passage forming member 28, and the flexible member 29 is formed a fourth passage 15d that connects the depression 32 of the first passage forming member 27 and the upper surface of the second passage forming member 28 to constitute the ink passage 15 in the ink supply unit 14. An end of the fourth passage 15d that opens on the upper surface of the second passage forming member 28 is connected to one end (the upstream end) of an ink supply tube 15e that constitutes the ink passage 15 in the ink supply units 14. The other end (the downstream end) of the ink supply tube 15e is connected to the valve unit 17 of the recording head 12.

As shown in FIG. 1, a part of the flexible member 29 serving as the suction side valve element 36 in the ink supply unit 14 has a through-hole 36a in the center thereof and is urged by the urging force of a coil spring 40 provided in the upper depression 33 toward the bottom surface of the lower depression 30. In this embodiment, the depressions 30 and 33, the suction side valve element 36, and the coil spring 40 constitute a suction side valve 41 that allows ink to flow therethrough only from the upstream side, which is the side of the ink cartridge 13, to the downstream side, where ink is consumed by being ejected by the recording head 12.

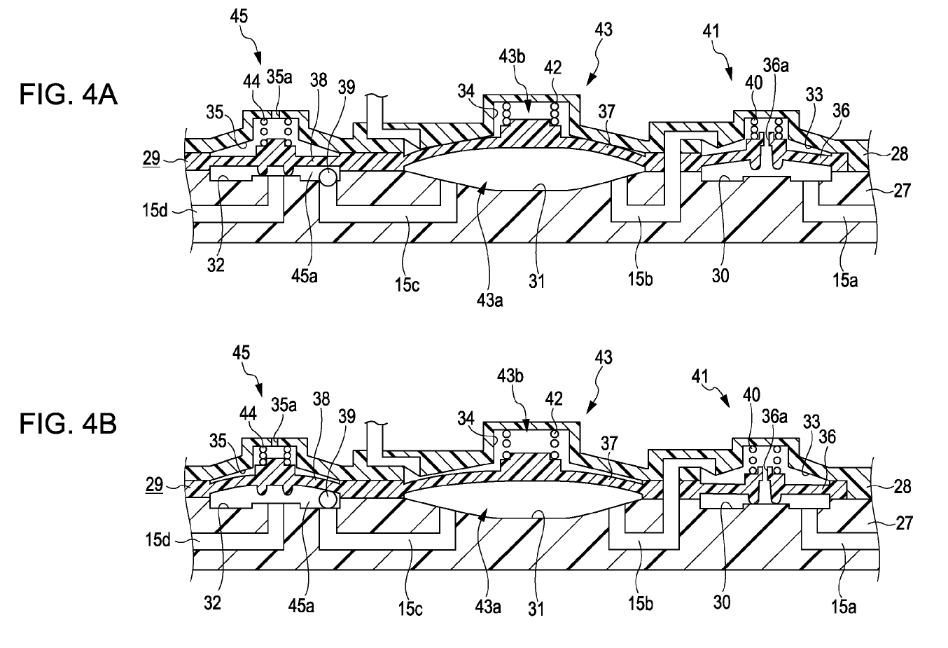

Similarly, a part of the flexible member 29 serving as the diaphragm 37 in the ink supply unit 14 is urged by the urging force of a coil spring 42 provided in the upper depression 34 toward the bottom surface of the lower depression 31. In this embodiment, the depressions 31 and 34, the diaphragm 37, and the coil spring 42 constitute a pulsatile pump 43, and the variable-volume space defined by the diaphragm 37 and the lower depression 31 functions as a pump chamber 43a (see FIG. 4) in the pump 43.

Similarly, a part of the flexible member 29 serving as the discharge side valve element 38 in the ink supply unit 14 is urged by the urging force of a coil spring 44 provided in the upper depression 35 toward the bottom surface of the lower depression 32. In this embodiment, the depressions 32 and 35, the discharge side valve element 38, and the coil spring 44 constitute a discharge side valve 45 serving as a liquid accumulator that accumulates ink under pressure. The variable-volume space defined by the discharge side valve element 38 and the lower depression 32 functions as an accumulating chamber 45a that constitutes the ink passage 15 and can accumulate ink under pressure. The volume of the accumulating chamber 45a is smaller than the volume of the pump chamber 43a and substantially the same as the volume of the space defined by the depression 30 and the suction side valve element 36. The urging force of the coil spring 44 acts in such a direction that the volume of the accumulating chamber 45a is reduced.

As shown in FIG. 1, the depression 34 of the second passage forming member 28 is connected via a bifurcated air passage 46 to a negative pressure generator 47 including a suction pump, and an air communication mechanism 48. The negative pressure generator 47 is configured to be driven by a driving force transmitted via a one-way clutch (not shown) when a reversible drive motor 49 rotates in the forward direction, thereby generating negative pressure so as to be able to generate negative pressure also in the depression 34 of the second passage forming member 28 connected to the negative pressure generator 47 via the air passage 46. In this regard, the variable-volume space defined by the depression 34 of the second passage forming member 28 and the diaphragm 37 functions as a negative pressure chamber 43b in which negative pressure is generated by the negative pressure generator 47.

The air communication mechanism 48 has a box 51 with an air communication port 50. The box 51 houses an air communication valve 53. A sealing member 52 is provided between the air communication port 50 and the air communication valve 53. The air communication valve 53 is normally urged by the urging force of a coil spring 54 in a valve closing direction such that the air communication port 50 is sealed. When the drive motor 49 rotates in the reverse direction, a cam mechanism 55 is driven by a driving force transmitted via a one-way clutch (not shown). The cam mechanism 55 displaces the air communication valve 53 against the urging force of the coil spring 54 in the valve opening direction. When there is a negative pressure in the negative pressure chamber 43b, which is connected to the air communication mechanism 48 via the air passage 46, the air communication valve 53 performs a valve opening operation to open the negative pressure chamber 43b to the atmosphere, thereby eliminating the negative pressure.

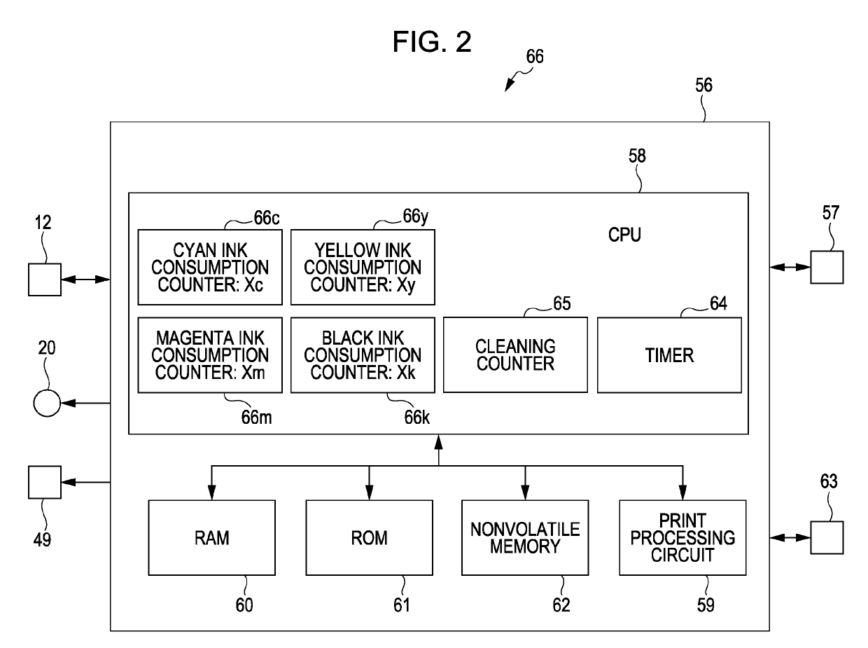

Although FIG. 1 shows a configuration in which a plurality of ink supply units 14 corresponding to a plurality of colors of ink are each provided with a negative pressure generator 47, an air communication mechanism 48, and a drive motor 49 for driving these, the invention is not limited to this. Alternatively, a common negative pressure generator 47, a common air communication mechanism 48, and a common drive motor 49 may be connected to the negative pressure chamber 43b of the pump 43 of each of a plurality of ink supply units 14 corresponding to a plurality of colors of ink via an air passage 46 dividing into the same number of branches as the number of the plurality of ink supply units 14. Since the plurality of ink supply units 14 share the single negative pressure generator 47, the single air vent mechanism 48, and the single drive motor 49, the printer 11 can be reduced in size. The drive motor 49 that drives the negative pressure generator 47 is connected to a control section 56 (see FIG. 2) serving as a control unit that controls the forward and reverse rotation or the start and stop.

As shown in FIG. 2, the control section 56 that performs the overall control of the operating condition of the printer 11 controls the recording head 12, the suction pump 20, and the drive motor 49 on the basis of print data input from a host computer 57 or an operation panel 63. In the following description, the c, m, y, and k attached to 66 denoting an ink consumption counter, X denoting an ink consumption count value, Q denoting a total consumption, and q denoting an ink consumption correspond to cyan, magenta, yellow, and black inks, respectively (for example, Qc denotes a total consumption of cyan ink).

Inside the control section 56, a CPU (central processing unit) 58, a print processing circuit (for example, a print processing integrated circuit composed of an ASIC (Application Specific Integrated Circuit) as a custom LSI) 59, and a PAM 60, a ROM 61, and a nonvolatile memory (EEPROM) 62 serving as storage units are connected so as to be able to exchange data among them.

The print data transmitted from the host computer 57 is temporarily stored in the RAM 60 and processed by the print processing circuit 59. On the basis of the processed data, the CPU 58 consumes ink by ejecting it from a corresponding nozzle 16 of the recording head 12. Printing and cleaning can also be performed from the operation panel 63 provided in the printer 11.

The kinds of cleaning include a manual cleaning that is performed on the basis of the operation of the host computer 57 or the operation panel 63 by an operator, a periodic cleaning that is performed at regular intervals, and a replacement cleaning that is performed when an ink cartridge is replaced. Examples of maintenance of the nozzles 16 include, in addition to cleaning, flushing in which ink is discharged from the nozzles 16 on the basis of a control signal unrelated to printing during printing. Thus, ink is also consumed in the cleaning and flushing as in printing. The ink consumption q consumed in cleaning (and flushing) differs depending on the mode and kind of cleaning (and flushing).

To measure the timing of the periodic cleaning, the CPU 58 has a timer 64. The CPU 58 measures the elapsed time since the last cleaning with the timer 64. When the elapsed time reaches a predetermined time, the CPU 58 controls the maintenance unit 18, thereby performing cleaning to suck ink out of the nozzles 16 of the recording head 12.

The timer 64 is also used for estimating the natural consuming of ink (the consuming of liquid) due to the evaporation from the nozzles 16. The natural consumption is estimated at regular intervals (for example, every week), as an ink consumption q (a unit liquid consumption) for each color.

As for the ink consumption q (unit liquid consumption) consumed in a single cleaning (single consuming of liquid), the cleaning counter 65 counts up the amount of ink sucked in cleaning, thereby counting the ink consumption q corresponding to each color.

The ink consumption counters 66 control the ink consumption q consumed in printing (consuming of liquid) for each color of ink. The same number of ink consumption counters as the number of colors of ink (four colors in this example) are provided.

The cleaning counter 65 and the ink consumption counters 66 may be, for example, counters (hardware) constituting the circuit in the CPU 58 or counter functions constructed as software by a program that the CPU 58 executes.

In this embodiment, the ink consumption counters 66 are used to obtain the ink consumption (unit liquid consumption) q consumed in printing on a sheet of recording paper as a unit of consuming of liquid. The ink consumption count values X (Xc, Xm, Xy, Xk) of the ink consumption counters 66 (66c, 66m, 66y, and 66k) each start from “zero.” Every time ink is ejected from the recording head 12, the number of ejections (that is, the number of dots) is counted up as the consumption.

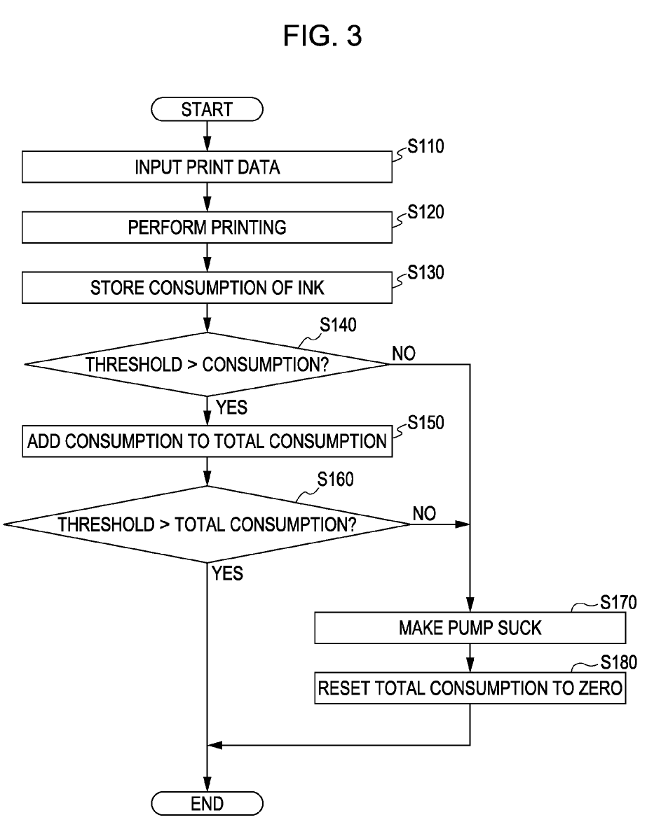

Next, the driving processes of the pump 43 using the drive motor 49 in the printer 11 configured as above will be described with reference to the flowchart of FIG. 3. Each process is performed by the CPU 58 in response to the consuming of ink in printing.

The plurality of (four in the invention) ink supply units 14 constituting the printer 11 have the same threshold S as the threshold consumption and total consumptions Q (Qc, Qm, Qy, and Qk) as individual total liquid consumptions.

The threshold S is a value preliminarily stored in the ROM 61 and is a value smaller than the amount calculated by subtracting the maximum ink consumption (maximum liquid consumption) q′ consumed in the printing on a sheet of recording paper from the amount L of ink (liquid) that the pump chamber 43a can supply from the ink cartridge 13 to the recording head 12 in a single driving (threshold S≦amount L of ink that can be supplied−maximum ink consumption q′). The total consumptions Q (Qc, Qm, Qy, and Qk) are values stored in the RAM 60 in every process and are calculated by individually adding the ink consumption q consumed in the printing on a sheet of recording paper to the corresponding total consumption Q. (For example, Qm←Qm+qm. Magenta total consumption Qm is replaced with a value calculated by adding magenta total consumption Qm and magenta ink consumption qm.) In step S110 of FIG. 3, print data is input from the host computer 57 or the operation panel 63. The printer 11 performs printing on the basis of the input print data (S120). After the printing on a sheet of recording paper is performed in step S120, each ink consumption q is stored individually in the RAM 60 on the basis of each ink consumption counter 66 in step S130. This ink consumption q also includes the ink consumption in the flushing performed during printing.

In step S130, the ink consumptions qc, qm, qy, and qk of all colors are obtained. In step S140, each ink consumption q is compared with the threshold S (determination process). If the ink consumptions qc, qm, qy, and qk are all smaller than the threshold S (S140: YES), each ink consumption q is added to the corresponding total consumption Q (S150). For example, the yellow total consumption Qy is replaced with a value calculated by adding the yellow ink consumption qy to the yellow total consumption Qy (Qy←Qy+qy).

In step S160, each updated total consumption Q is compared with the threshold S (determination process). If the total consumptions Qc, Qm, Qy, and Qk are all smaller than the threshold value S (S160: YES), the process ends.

If at least one of the ink consumptions q and the total consumptions Q exceeds the threshold S (S140: NO, S160: NO), in step S170, the control section 56 rotates the drive motor 49 in the forward direction, thereby driving all the pumps 43 (pump driving process). Zero is substituted for each total consumption Q (S180).

When the ink consumption q consumed in the natural consuming and cleaning is obtained, the ink consumption q of each color is stored in the RAM 60. As in printing, the processes of step S140 to step S180 are performed to determine the need for driving the pump 43 (determination process). If it is determined that the pump 43 needs to be driven, the pump 43 is driven (pump driving process). That is, each total consumption Q is the total amount of each color of ink that has been consumed in printing, cleaning, and natural consuming since the last suction of the pump 43.

Next, the working of the printer 11 in which the above processes are performed will be described, specifically focusing on the working of the pump 43 in the ink supply units 14. FIG. 1 shows the condition just after an ink cartridge is replaced with new one. The suction side valve element 36 of the suction side valve 41, the diaphragm 37 of the pump 43, and the discharge side valve element 38 of the discharge side valve 45 are pressed against the bottom surfaces of the lower depressions 30, 31, and 32 by the urging forces of the coil springs 40, 42, and 44. The ball valve 39, which can open and close the third passage 15c in the ink passage 15 of the ink supply unit 14, is retained at the valve closing position by the corresponding urging member (not shown). In addition, the air communication mechanism 48 is in the valve closing condition in which the air communication valve 53 closes the air communication port 50.

When the ink supply unit 14 supplies ink from the ink cartridge 13 to the recording head 12, first, the drive motor 49 is rotated in the forward direction to drive the pump 43. The negative pressure generator 47 generates negative pressure, and negative pressure is generated in the negative pressure chamber 43b of the ink supply unit 14 connected to the negative pressure generator 47 via the air passage 46. As a result, the diaphragm 37 of the pump 43 is elastically deformed (displaced) against the urging force of the coil spring 42 to the side of the negative pressure chamber 43b, thereby reducing the volume of the negative pressure chamber 43b (see FIG. 4A). With the reduction in volume of the negative pressure chamber 43b, the volume of the pump chamber 43a of the pump 43, which is in abutment with the negative pressure chamber 43b with the diaphragm 37 therebetween, increases.

That is, the pump 43 displaces the diaphragm 37 in such a direction that the volume of the pump chamber 43a increases, thereby performing a suction stroke. Specifically, the diaphragm 37 is displaced from the bottom dead center shown in FIG. 1 to the top dead center shown in FIG. 4A. So, negative pressure is generated in the pump chamber 43a. The negative pressure acts on the upper depression 33 of the suction side valve 41 via the second passage 15b. The difference in pressure between the upper and lower depressions 33 and 30 elastically deforms (displaces) the suction side valve element 36 upward (that is, in the valve opening direction) against the urging force of the coil spring 40. As a result, the first passage 15a is brought into communication with the second passage 15b via the through-hole 36a of the suction side valve element 36, and ink is sucked from the ink cartridge 13 via the first passage 15a, the depression 30, the through-hole 36a, the depression 33, and the second passage 15b into the pump chamber 43a.

When the pump 43 performs a suction stroke, the negative pressure in the pump chamber 43a also acts on the downstream side of the ink passage 15 via the third passage 15c. However, the downstream end of the third passage 15c is closed by the ball valve 39 and is not opened unless an ink discharge pressure of a predetermined positive pressure (for example, of 3 kPa or more) is exerted on the ball valve 39 from the upstream side of the third passage 15c by a discharge stroke of the pump 43. In this case, negative pressure acts on the ball valve 39 so the ball valve 39 is maintained closed.

Next, in the condition shown in FIG. 4A, the drive motor 49 is rotated in the reverse direction. The cam mechanism 55 of the air communication mechanism 48 opens the air communication valve 53 against the urging force of the coil spring 54, thereby opening the negative pressure chamber 43b under negative pressure to the atmosphere. At this time, the amount L of ink that can be supplied to the recording head 12 is the maximum, and an amount of ink that can be supplied by a single pump driving is supplied under pressure to the downstream side. The diaphragm 37 of the pump 43 is elastically deformed (displaced) by the urging force of the coil spring 42 downward (that is, toward the bottom surface of the pump chamber 43a), thereby increasing the volume of the negative pressure chamber 43b (see FIG. 4B). With the increase in volume of the negative pressure chamber 43b, the volume of the pump chamber 43a of the pump 43, which is in abutment with the negative pressure chamber 43b with the diaphragm 37 therebetween, decreases.

That is, the pump 43 displaces the diaphragm 37 in such a direction that the volume of the pump chamber 43a is reduced, thereby performing a discharge stroke. Specifically, as shown in FIG. 4B, the diaphragm 37 is displaced from the top dead center slightly toward the bottom dead center, thereby exerting a predetermined pressure (for example, of about 30 kPa) on the ink sucked into the pump chamber 43a. So, ink is discharged out of the pump chamber 43a. The discharge pressure acts on the upper depression 33 of the suction side valve 41 via the second passage 15b and elastically deforms (displaces) the suction side valve element 36 downward (that is, in the valve closing direction) in cooperation with the urging force of the coil spring 40. As a result, the first passage 15a is brought out of communication with the second passage 15b by the valve closing operation of the suction side valve element 36, and the suction of ink from the ink cartridge 13 to the pump chamber 43a via the suction side valve 41 is stopped, and the ink discharged from the pump chamber 43a by the discharge stroke of the pump 43 is prevented from flowing back via the suction side valve 41 to the ink cartridge 13.

When the pump 43 performs a discharge stroke, the pressure of ink discharged from the pump chamber 43a also acts on the downstream side of the ink passage 15 via the third passage 15c. So, the discharge pressure of the pump 43 opens the closed ball valve 39, and the accumulating chamber 45a of the discharge side valve 45, which is defined by the discharge side valve element 38 and the lower depression 32, is brought into communication with the pump chamber 43a via the third passage 15c. As a result, ink is supplied under pressure from the pump chamber 43a via the third passage 15c to the accumulating chamber 45a of the discharge side valve 45.

In the discharge side valve 45, the pressure of ink supplied under pressure to the accumulating chamber 45a elastically deforms (displaces) the discharge side valve element 38 against the urging force of the coil spring 44 upward (that is, in the valve opening direction). As a result, as shown in FIG. 4B, ink is accumulated under pressure in the accumulating chamber 45a. The urging force of the coil spring 44 in the discharge side valve 45 is set, for example, to about 13 kPa so that, when ink flows into the accumulating chamber 45a at a discharge pressure that can open the ball valve 39, the discharge side valve element 38 can be elastically deformed upward by the pressure of the ink.

The discharge pressure of ink pressurized by the diaphragm 37 and discharged from the pump chamber 43a is thereafter maintained balanced in each region of the ink passage 15 downstream of the upper depression 33 of the suction side valve 41 (including the pump chamber 43a and the accumulating chamber 45a). That is, in the accumulating chamber 45a, the discharge side valve element 38 is maintained at the top dead center, and the accumulating chamber 45a and the fourth passage 15d are maintained in communication with each other.

Thereafter, ink is ejected from the recording head 12 onto recording paper (not shown), and an amount of ink corresponding to the amount of ink consumed in the ink ejection is supplied via the valve unit 17 from the ink passage 15 to the recording head 12. So, with the consuming of ink on the downstream side (on the side of the recording head 12), a corresponding amount of ink is supplied from the pump chamber 43a via the accumulating chamber 45a to the recording head 12 on the downstream side, being pressurized by the pressing force of the diaphragm 37 urged by the urging force of the coil spring 42 in such a direction that the volume of the pump chamber 43a decreases.

When a printing operation that consumes a small amount of ink (ink consumption q per sheet<threshold S) is performed on a plurality of sheets of recording paper, since the ink consumption q is smaller than the threshold S, the ink consumption q is added to the total consumption Q every time the printing operation is performed on a sheet of recording paper. Let's assume that the printing operation is performed until the total consumption Q becomes slightly smaller than the threshold S (total consumption Q<threshold S, and total consumption Q≈threshold S).

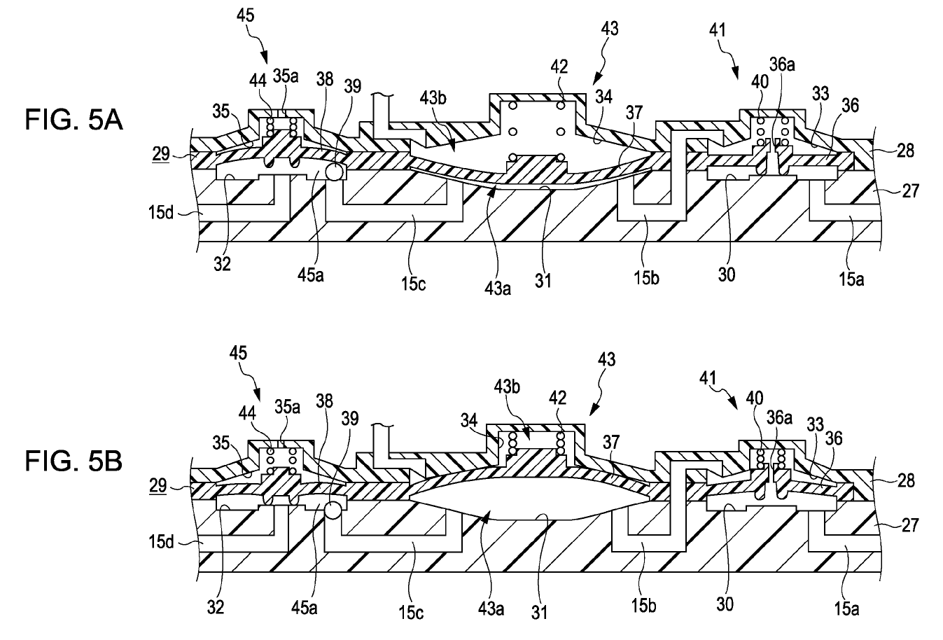

When, in this condition, a printing operation that consumes a large amount of ink per sheet (ink consumption q maximum ink consumption q′) is performed, the diaphragm 37 is displaced to near the bottom dead center as shown in FIG. 5A. At this time, of the ink consumption q and the total consumption Q, at least the total consumption Q is larger than the threshold S. When a printing operation that consumes a small amount of ink per sheet is performed a number of times, the total consumption Q can become slightly larger than the threshold S (total consumption Q>threshold S, and total consumption Q≈threshold S).

In a condition in which the maximum amount of ink is retained in the pump chamber 43a of the pump 43 just after a suction stroke as shown in FIG. 4B, when a printing operation that consumes a large amount of ink per sheet (ink consumption q>threshold S) is performed, the ink consumption q is larger than the threshold S.

When the total consumption Q or the ink consumption q is larger than the threshold S, the CPU 58 rotates the drive motor 49 in the forward direction again to make the pump 43 perform a suction stroke. So, in the air communication mechanism 48, the air communication valve 53 is displaced to the valve closing position so as to close the air communication port 50, and the negative pressure generator 47 generates negative pressure in the negative pressure chamber 43b, and the diaphragm 37 is elastically deformed (displaced) against the urging force of the coil spring 42 to the side of the negative pressure chamber 43b. That is, the pump 43 starts a suction stroke again. As a result, as shown in FIG. 5B, the diaphragm 37 is displaced to the top dead center to increase the volume of the pump chamber 43a, thereby generating negative pressure in the pump chamber 43a. The negative pressure elastically deforms (displaces) the suction side valve element 36 in the valve opening direction. So, the first passage 15a and the second passage 15b are brought into communication with each other via the through hole 36a of the suction side valve element 36, and ink is sucked out of the ink cartridge 13 into the pump chamber 43a again.

In the accumulating chamber 45a downstream of the pump chamber 43a, the ball valve 39 is displaced to the valve closing position by the reduction in the pressure in the pump chamber 43a relative to the pressure in the accumulating chamber 45a. Since the discharge side valve element 38 is pressed by the coil spring 44, ink keeps being supplied under pressure from the accumulating chamber 45a via the fourth passage 15d to the recording head 12 on the downstream side also during the suction stroke of the pump 43. Thereafter, the same discharge stroke of the pump 43 as described above is performed, and ink is supplied under pressure from the pump chamber 43a via the accumulating chamber 45a on the downstream side to the recording head 12.

The ink supply unit 14 and the printer 11 of the above embodiment have the following advantageous effects: (1) The need for driving the pump is determined after the printing in the recording head 12. If it is determined that the pump needs to be driven, the pump is driven. The pump is not driven just before the consuming of ink, such as printing, in the recording head 12. Since the consuming of ink, such as printing, is not delayed by being interrupted by the pump driving, the efficiency of the printing in the recording head 12 can be improved.

(2) The need for driving the pump is determined on the basis of the ink consumption q consumed in printing. When the ink consumption q is small, the pump is not driven. So, the number of times of suction strokes is small compared to the case where a suction stroke is performed every time printing is performed. Thus, it is possible to extend the time the ink supply unit 14 can supply ink and to improve its supply rate.

(3) If the ink consumption q consumed in the printing on a sheet of recording paper is smaller than the threshold S, the ink consumption q is added to the total consumption Q. When the total consumption Q becomes larger than the threshold S, the pump 43 is driven. So, even when the ink consumption q varies by sheet of recording paper, the ink consumption q can be prevented from exceeding the amount L of ink that can be supplied.

(4) In a condition in which the pump 43 performs a suction stroke and the amount L of ink that can be supplied is the maximum, when the same amount of ink as the threshold S is consumed, the amount L of ink that can be supplied is larger than the maximum ink consumption q′ required for the printing on a sheet of recording paper. If the ink consumption q is smaller than or equal to the threshold S, ink can be supplied without driving the pump during the printing on a sheet of recording paper.

(5) Even in the case where the ink consumption in the recording head 12 varies by color of ink, when any one of the ink consumptions qc, qm, qy, and qk exceeds the threshold S, all the pumps 43 are driven. So, the amount L of ink that can be supplied can be increased in every ink supply unit 14 in a short time compared to the case where the pumps are individually driven.

(6) The ink supplied to the recording head 12 is ejected onto recording paper as a target during printing. After ink is ejected onto recording paper for printing, if it is determined that the pump needs to be driven, the pump is driven. Since the need for driving the pump is determined after printing, the waiting time from an instruction to eject ink to the start of ink ejection can be shortened, and the efficiency of ink ejection can be improved. In addition, since the need for driving the pump is determined every time ink is ejected onto a unit of recording paper (target), the need for driving the pump during the ejection can be reduced and the efficiency of ink ejection onto recording paper can be improved.

The above embodiment may be modified as follows. The ink supply unit 14 may have a single ink passage 15 and a single ink cartridge 13. In addition, the printer 11 may have a single ink supply unit 14.

When a plurality of ink passages 15 are provided, instead of obtaining all the ink consumptions qc, qm, qy, and qk and then comparing them with the threshold S, the ink consumptions may be compared with the threshold S sequentially in the order in which the ink consumptions are obtained, to determine the need for driving the pump. Since the need for driving the pump can be determined as soon as any one of the ink consumptions q exceeds the threshold S, the time required for determination can be shortened.

The plurality of pumps 43 may be driven individually on the basis of the threshold S and the ink consumptions q. The pumps 43 provided in the plurality of ink passages 15 may have pump chambers 43a with different volumes. That is, for example, when black ink is used in larger amounts than the other inks, the threshold S for the black ink consumption qk can be increased by making the pump 43 of the ink supply unit 14 corresponding to black ink larger than the other pumps 43. Thus, the number of times it is determined that the pump needs to be driven can be reduced, and printing can be performed efficiently.

The threshold S may be set for the amount L of ink that can be supplied. In that case, the threshold S is larger than the maximum ink consumption q′ consumed in the printing on a sheet of recording paper (S≧q′). When a value calculated by subtracting the ink consumption q from the amount L of ink that can be supplied is smaller than the threshold S (S≧L−q), it is determined that the pump needs to be driven. If it is not determined that the pump needs to be driven, the value calculated by subtracting the ink consumption q from the amount L of ink that can be supplied is stored (L←L−q). When the amount L of ink that can be supplied is smaller than the threshold S (S≧L) it is determined that the pump needs to be driven.

Recording media as targets are not limited to sheets of recording paper of the same size but include continuous form paper, special paper with different ink absorbability, and plain paper. Recording media are not limited to paper but include resin films, cloth, and metal tapes.

The unit of the consuming of ink can be determined on the basis of any one of the number of sheets, the printing area in a single sheet of recording paper, the size of recording paper, the consumable amount per unit, and so forth. However, the maximum ink consumption q′ per unit needs to be smaller than the amount L of ink that can be supplied by a single suction stroke and a single discharge stroke of the pump 43.

Instead of the negative pressure generator 47, a (positive) pressure generator may be used as a drive source of the pump 43. Instead of a compression spring, a tension spring may be used as the coil spring 42 serving as an urging member. The compression coil spring 42 may be provided in the pump chamber 43a instead of the negative pressure chamber 43b. In the case of such a modification, when the pump 43 performs a suction stroke, the diaphragm 37 is displaced by the urging force of the spring so as to increase the volume of the pump chamber 43a, and when the pump 43 performs a discharge stroke, pressurized air is introduced from the pressure generator into the upper depression 34 (the negative pressure chamber 43b in the embodiment) of the pump 43.

Instead of the negative pressure generator 47 or the pressure generator, a cam mechanism may be used as a mechanism that displaces the diaphragm 37. For example, the proximal end of a pulling member with an engaging portion is fixed to the diaphragm 37 pressed by a compression coil spring 42. A cam member is brought into contact with the engaging portion of the pulling member and displaces the diaphragm 37 with the pulling member therebetween. When a tension spring is used, the proximal end of a pressing member is fixed to the diaphragm 37, and the distal end thereof is pressed by a cam member to the side of the diaphragm 37.

In the pump 43 and the accumulating chamber 45a, urging members other than coil springs, for example, leaf springs or rubbers can also be used to urge the diaphragm 37 and the discharge side valve element 38. By such urging members, the urging force exerted on the ink in the pump chamber 43a and the accumulating chamber 45a can be maintained regardless of the drive status of the negative pressure generator 47.

The pump 43 may be a piston pump that directly presses the pump chamber 43a with a piston capable of reciprocating in the negative pressure chamber 43b and changes the volume of the pump chamber 43a with the reciprocating motion. Similarly, the accumulating chamber 45a can have a piston structure.

Examples of “liquid” in this specification include liquids other than ink (including inorganic solvent, organic solvent, solution, liquid resin, and liquid metal (molten metal)), liquids in which particles of a functional material are dispersed or mixed, and gelled liquids. Liquid ejecting apparatuses that ejects or discharges such a “liquid” may include, for example, liquid ejecting apparatuses that eject a liquid in which a material such as an electrode material or a color material (pixel material) used for manufacturing liquid crystal displays, EL (electroluminescence) displays, and field emission displays is dispersed or dissolved, liquid ejecting apparatuses that eject bioorganic matter used for manufacturing biochips, and liquid ejecting apparatuses that are used as a precise pipette and eject a sample liquid. Liquid ejecting apparatuses further include liquid ejecting apparatuses that eject lubricating oil onto precision machines such as watches and cameras in a pinpoint manner, liquid ejecting apparatuses that eject transparent resin liquid such as ultraviolet curable resin onto a substrate to form a micro hemispherical lens (optical lens) used in an optical communication element, liquid ejecting apparatuses that eject etching liquid such as acid or alkali to etch a substrate, and liquid ejecting apparatuses that eject gelled liquid such as physical gel.

Although a liquid ejecting apparatus is embodied into an ink jet printer 11 in the above embodiment, a liquid ejecting apparatus that ejects or discharges a liquid other than ink may be adopted. The invention is applicable to various types of liquid ejecting apparatuses with a liquid ejecting head that discharges very small drops. The term “drop” means the form of liquid discharged from the liquid ejecting apparatus. The forms include a round shape, a teardrop shape, and a thread shape. The term “liquid” used here means a material that a liquid ejecting apparatus can discharge. Liquids only have to be substances in liquid phase and include high-viscosity or low-viscosity liquid, sol, gel water, other liquids such as inorganic solvent, organic solvent, solution, liquid resin, and liquid metal (molten metal). Liquids include not only liquid as a state of matter but also liquids such that particles of a solid functional material such as pigment or metal particles are dissolved, dispersed or mixed in a solvent. Typical examples of liquid include ink and liquid crystal such as those described in the above embodiment. Inks include water-based ink, oil-based ink, and various types of liquid compositions such as gel ink and hot-melt ink. Liquid ejecting apparatuses may include, for example, liquid ejecting apparatuses that eject a liquid in which a material such as an electrode material or a color material used for manufacturing liquid crystal displays, EL (electroluminescence) displays, and field emission displays is dispersed or dissolved, liquid ejecting apparatuses that eject bioorganic matter used for manufacturing biochips, liquid ejecting apparatuses that are used as a precise pipette and eject a sample liquid, textile printing apparatuses, and microdispensers. In addition, liquid ejecting apparatuses that eject lubricating oil onto precision machines such as watches and cameras in a pinpoint manner, liquid ejecting apparatuses that eject transparent resin liquid such as ultraviolet curable resin onto a substrate to form a micro hemispherical lens (optical lens) used in an optical communication element, and liquid ejecting apparatuses that eject etching liquid such as acid or alkali to etch a substrate may be adopted. The invention can be applied to any one of these types of liquid ejecting apparatuses.

What is claimed is:

1. A liquid supply unit comprising:
at least one liquid supply passage that supplies liquid from a liquid supply source on the upstream side to a liquid consuming section on the downstream side;
a pump that operates using a part of the liquid supply passage as a pump chamber; and
a control unit that determines the need for driving the pump after the consuming of liquid in the liquid consuming section and drives the pump on the basis of the determination.

2. The liquid supply unit according to claim 1, wherein the control unit drives the pump when the control unit determines that the liquid consumption consumed in the consuming of liquid in the liquid consuming section is larger than or equal to a threshold consumption preliminarily set as a datum for determining that the pump needs to be driven.

3. The liquid supply unit according to claim 2, wherein when the control unit determines that a unit liquid consumption consumed in a unit of consuming of liquid in the liquid consuming section is smaller than the threshold consumption, the control unit stores the unit liquid consumption in a predetermined storage unit as a total liquid consumption, and when the control unit determines that the total liquid consumption is larger than or equal to the threshold consumption, the control unit drives the pump.

4. The liquid supply unit according to claim 2, wherein the threshold consumption is set so as to be smaller than or equal to an amount obtained by subtracting the maximum liquid consumption that can be consumed in a unit of consuming of liquid in the liquid consuming section from the amount of liquid that can be supplied from the liquid supply source to the liquid consuming section by a single driving of the pump.

5. The liquid supply unit according to claim 2, wherein the at least one liquid supply passage includes a plurality of liquid supply passages that can supply different liquids from their respective liquid supply sources on the upstream side to the liquid consuming section on the downstream side by the operation of their respective pumps, and when the control unit determines that the consumption of at least one of the liquids supplied via the plurality of liquid supply passages is larger than or equal to the threshold consumption, the control unit drives all the pumps.

6. A liquid ejecting apparatus comprising:
a liquid consuming section that consumes liquid at least by ejecting liquid onto a target; and
a liquid supply unit according to claim 1 that supplies liquid to the liquid consuming section from a liquid supply source.

7. A method for supplying liquid to a liquid consuming section via a liquid supply passage that supplies liquid from a liquid supply source on the upstream side to the liquid consuming section on the downstream side by driving a pump that has a pump chamber constituting the liquid supply passage, the method comprising:
determining the need for driving the pump after the consuming of liquid in the liquid consuming section; and
driving the pump on the basis of the determination.

8. The method according to claim 7, wherein it is determined whether or not the liquid consumption consumed in the consuming of liquid in the liquid consuming section is larger than or equal to a threshold consumption preliminarily set as a datum for determining that the pump needs to be driven.

9. The method according to claim 8, wherein when it is determined that a unit liquid consumption consumed in a unit of consuming of liquid in the liquid consuming section is smaller than the threshold consumption, the unit liquid consumption is stored in a predetermined storage unit as a total liquid consumption, and it is determined whether or not the total liquid consumption is larger than or equal to the threshold consumption.
